(19) United States
(12) Patent Application Publication
(10) Pub. No.: US 2008/0190937 A1
(43) Pub. Date: Aug. 14, 2008

(54) Food and Drink Packing Vessel

(76) Inventor: Dong Sung Cho, Seoul (KR)

Correspondence Address: BIRCH STEWART KOLASCH & BIRCH, PO BOX 747, FALLS CHURCH, VA, 22040-0747, US

(21) Appl. No.: 11/914,504

(22) PCT Filed: May 11, 2006
(86) PCT No.: PCT/KR06/01759

§ 371 Date: Nov. 15, 2007

Related U.S. Application Data
(60) Provisional application No. 60/679,435, filed on May 9, 2005.
(60) Provisional application No. 60/679,965, filed on May 10, 2005.
(60) Provisional application No. 60/680,978, filed on May 13, 2005.

(51) Int. Cl. A47J 27/00; A47G 19/00; B65D 17/34; B65D 43/00

(52) U.S. Cl. 220/573.1; 220/574; 220/359.2; 220/359.4

(57) ABSTRACT

The present invention provides a food and drink packing container, in which a transparent vinyl film type cover is attached to an upper rim of the container by heat-sealing, and which has a structure such that the container can be easily opened when desired, because the interior and the exterior thereof are caused to communicate. The food and drink packing container of the present invention includes a container body (2), which contains food and drink therein and has a flange (4) on an upper end thereof, and a film type cover (3), which is attached to the flange by heat-sealing to prevent the food and drink from spilling from the container body. At least one projecting part (5) extends outwards from the flange and is covered with the cover, and a boring protrusion (6) for boring a hole through the cover is provided in the projecting part.

### TECHNICAL FIELD

The present invention relates, in general, to food and drink packing containers and, more particularly, to a food and drink packing container, in which a transparent vinyl film type cover is attached to an upper rim of the container by heat-sealing, and which has a structure such that the container can be easily opened when desired because the interior and the exterior thereof are caused to communicate with each other.

### BACKGROUND ART

Generally, containers, which are made of synthetic resin and are used for packing food and drink such as boiled fish paste, are manufactured in various shapes. Here, the term “container” is used to have the same meaning as the term “vessel”. Contents are inserted into such a container through an opening thereof and thereafter, a cover, which is made of a vinyl sheet or aluminum foil, the inner surface of which is coated with a vinyl layer, is airtightly attached to the rim of the container by heat-sealing. That is, the container is reliably sealed by the cover.

In the conventional containers, methods of heat-sealing the cover onto the container are classified into a method in which a plurality of corrugations is formed in the perimeter of the cover, which is made of silver foil and is attached to the rim of the container by hot-pressing, so that the perimeter of the cover is attached to the rim of the container, and a method in which a vinyl sheet cover, having a size corresponding to the upper flange of the container, is airtightly attached to the upper flange of the container by heat-sealing, or the cover is airtightly attached to the upper flange of the container by heat-sealing such that part of the perimeter of the cover protrudes outwards from the upper flange of the container.

When a user opens the conventional container having the above-mentioned structure to consume the contents of the container, in the case in which the part of the flange of the container which is attached to the cover by heat-sealing is relatively small, for example, in the case of a yoghurt container, since the area of the cover and the force with which the cover is heat-sealed to the flange of the container are relatively small, the container can be easily opened. However, in the case in which a vinyl sheet cover is attached to the flange of the container by hot-pressing and the area of the cover which is attached to the flange is relatively large, since the heat-sealing force is increased in proportion to the area of the cover, it is difficult to remove the cover from the container.

In other words, in the case that an area of the cover is relatively large, for example, in the case of a container for boiled fish paste, heat-sealing force of the cover attached to the container must be relatively large to prevent the cover from being undesirably opened by the weight of content contained in the container. However, in the case of this container, due to pressure difference between the interior and the exterior of the container as well as due to excessively large heat-sealing force of the cover attached to the container, very large force is required to open the cover.

### DISCLOSURE OF INVENTION

### Technical Problem

As described above, in the case of the boiled fish paste container having a relatively large area, a large force must be applied thereto in order to open the cover. In this case, there is a problem in that the contents may spill.

Accordingly, an object of the present invention is to provide a food and drink packing container, which has a structure such that a cover can be easily opened with a relatively small force even if the area of the cover which is attached to the upper end of the container is relatively large.

### BRIEF DESCRIPTION OF THE DRAWINGS

FIG. 1 is a view of a food and drink packing container having an opening pin, according to the present invention;

FIG. 2 is a perspective view of the food and drink packing container exploded to show the state in which a cover is separated from a container body, according to the present invention;

FIG. 3 is a sectional view of the food and drink packing container of the present invention, taken along the line II-II of FIG. 1;

FIG. 4 is a sectional view of a food and drink packing container having another type of opening pin, according to the present invention;

FIG. 5 is a perspective view of a food and drink packing container having another type of opening pin, according to the present invention; and

FIG. 6 is a sectional view showing the operation of the food and drink packing container of FIG. 5.

### DESCRIPTION OF THE ELEMENTS IN THE DRAWINGS

1: food and drink packing container 2: container body

3: cover 4: flange

5: projecting part 6: boring protrusion

7: bending groove 8: hole

### BEST MODE FOR CARRYING OUT THE INVENTION

In order to accomplish the above object, in an aspect, the present invention provides a food and drink packing container, including: a container body to contain food and drink therein, with a flange provided on an upper end of the container body; and a film type cover attached to the flange by heat-sealing to prevent the food and drink from spilling from the container body. At least one projecting part extends outwards from the flange and is covered with the cover, and a boring protrusion for boring a hole through the cover is provided at a predetermined position in the projecting part.

In another aspect, the present invention provides a food and drink packing container, including: a container body to contain food and drink therein, with a flange provided on an upper end of the container body; and a film type cover attached to the flange by heat-sealing to prevent the food and drink from spilling from the container body. At least one projecting part extends outwards from the flange and is covered with the cover, and a boring protrusion for boring a hole through the cover is provided at a predetermined position on a part of the cover which is bonded to the projecting part.

The boring protrusion may be provided on the projecting part, and a passing hole may be formed through the cover at a position corresponding to the boring protrusion.

The boring protrusion may be formed by protruding part of the projecting part upwards using forming means after the projecting part is covered with the cover.

Furthermore, a bending groove may be formed in a lower surface of the projecting part to facilitate bending of the projecting part.

The boring protrusion may be made of material having a higher stiffness than that of the cover such that the boring protrusion bores the hole through the cover, but having a lower stiffness than that of the container body to prevent the container body from being scratched by contact with the boring protrusion.

Hereinafter, a preferred embodiment of the present invention will be explained in detail with reference to the attached drawings.

### Mode for the Invention

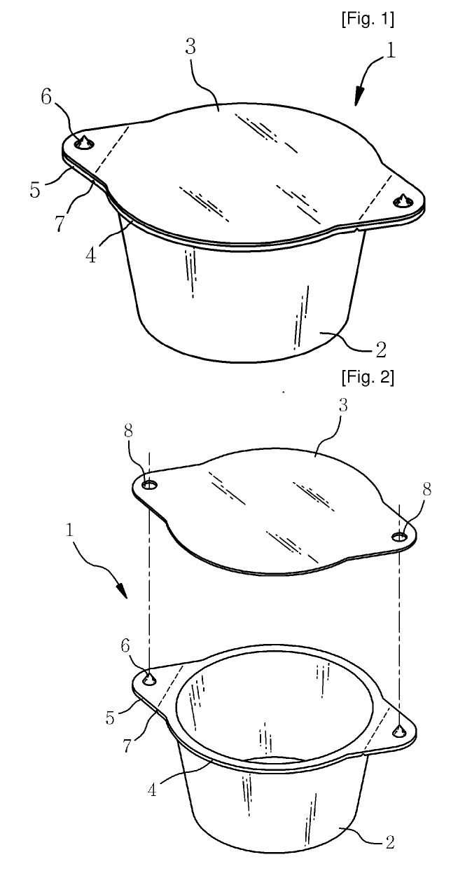

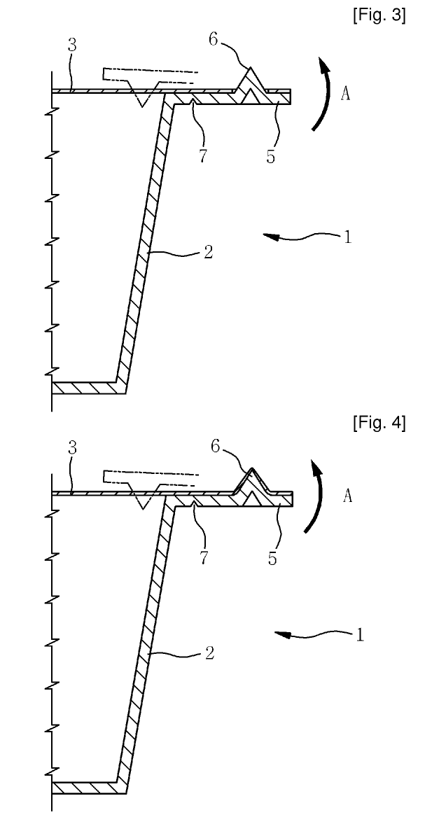

FIG. 1 is a view of a food and drink packing container having an opening pin, according to the present invention. FIG. 2 is a perspective view of the food and drink packing container exploded to show the state in which a cover is separated from a container body, according to the present invention. FIG. 3 is a sectional view of the food and drink packing container of the present invention, taken along the line II-II of FIG. 1.

As shown in FIGS. 1 through 3, in the food and drink packing container 1 of the present invention, the cover 3 made of a vinyl film is attached to a flange 4, which is formed on the upper edge of the container body 2 by hot-pressing to seal the open upper end of the container body 2, in the same manner of a conventional food and drink packing container. The flange 4 has at least one projecting part 5, which extends outwards, according to the intended purpose. A boring protrusion 6, which has a conical shape and a predetermined height, is provided on the projecting part 5. The boring protrusion 6 is securely attached at a predetermined position to the projecting part 5 using a bonding means such as an adhesive.

In the present invention, the cover 3, which is attached to the flange 4 of the container body 2 by hot-pressing, is also attached to the upper surface of the projecting part 5, which extends outwards from the flange 4, by hot-pressing. Here, when the cover 3 is attached to the projecting part 5, due to the boring protrusion 6 provided on the projecting part 5, the process of attaching the cover 3 to the projecting part 5 may not be easy. Therefore, to easily attach the cover 3 to the projecting part 5, a hole 8 (see, FIG. 2) is formed through the cover 3 at a position corresponding to the boring protrusion 6. Then, when the cover 3 is attached to the projecting part 5, the boring protrusion 6 is inserted into the hole 8 formed through the cover 3. Thus, the cover 3 can be easily attached to the projecting part 5.

Preferably, the boring protrusion 6, which is provided on the projecting part 5 of the flange 4 of the container body 2, is made of material which is stiffer than that of the cover 3 such that the boring protrusion 6 can easily bore a hole in the cover 3, but is less stiffer than that of the container body 2, to prevent the container body 2 from being scratched by contact with the boring protrusion 6 while the food and drink packing container 1 is carried.

Meanwhile, a bending groove 7 is formed in the lower surface of the projecting part 5 on which the boring protrusion 6 is provided. Because of the bending groove 7, the projecting part 5 can be easily bent in the direction designated by the arrow (A) of FIG. 3. When the projecting part 5 is bent in the direction of the arrow (A), the tip of the boring protrusion 6 is brought into contact with the cover 3, as shown by the double-dot-dashed line. When the projecting part 5 is pushed downwards, the boring protrusion 6, being stiffer than the cover 3, bores a hole through the cover 3.

As such, when the hole is formed through the cover 3 by the boring protrusion 6, the interior of the food and drink packing container 1 communicates with the outside of the food and drink packing container 1 through the hole formed through the cover 3. Therefore, the pressure between the interior and the exterior of the food and drink packing container 1 is equilibrated. Then, when the projecting part 5, which is connected to the cover 3, is pulled upwards by a user, the cover 3, which has been attached to the flange 4 of the food and drink packing container 1 by heat-sealing, is easily separated from the flange 4.

Meanwhile, as shown in FIG. 4, the boring protrusion 6 to be provided on the projecting part 5 of the flange 4 may be formed by pressing the projecting part 5 upwards using a pointed forming means. In this case, the cover 3, which is typically made of a vinyl film or an aluminum film, is attached to the projecting part 5 by heat-sealing before the boring protrusion 6 is formed in the projecting part 5 by the pointed forming means. The part of the cover 3 which is attached to the projecting part 5 expands when the boring protrusion 6 is formed in the projecting part 5 by the pointed forming means, thus keeping the boring protrusion 6 covered.

In the case that the boring protrusion 6 is covered with the cover 3, as shown in FIG. 4, part of the cover 3 preferably protrudes outwards from the projecting part 5 in which the boring protrusion 6 is formed by the pointed forming means. In this case, before the boring protrusion 6 is used to bore a hole in the cover 3, the cover 3 is separated from the projecting part 5 using the protruding part of the cover 3. Then, when the boring protrusion 6 penetrates the food and drink packing container 1 to form the hole through the cover 3, the contents of the food and drink packing container 1 are prevented from being contaminated by foreign substances, such as dust, which is present on the boring protrusion 6. At this time, the protruding part of the cover 3, which is detached from the projecting part 5, is preferably folded to one side such that the protruding part of the cover 3 does not interfere with the boring protrusion 6 boring the cover 3.

Meanwhile, when the cover 3 is opened from the container body 2 after a hole has been formed through the cover 3 by the boring protrusion 6, to prevent liquid contents from being undesirably discharged through the hole formed through the cover 3, it is preferable that the cover 3 be opened from the projecting part 5, which is adjacent to the hole formed by the boring protrusion 6, to the opposite side.

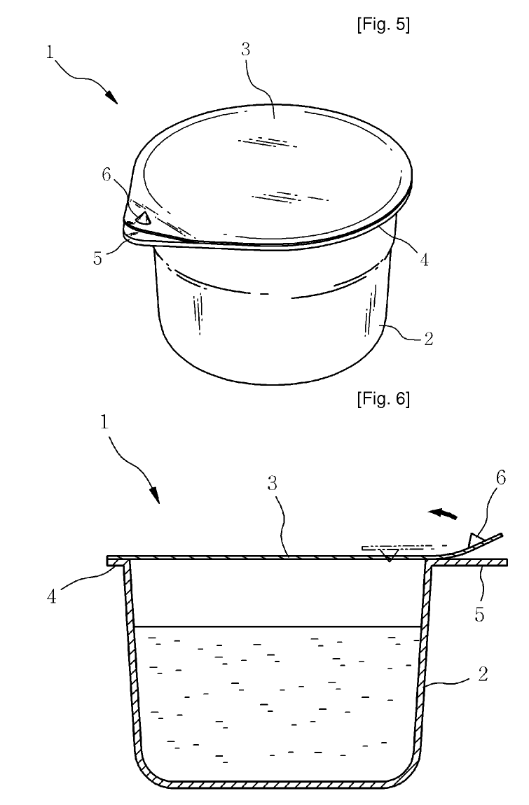

FIG. 5 is a perspective view showing a food and drink packing container having another type of opening pin, according to the present invention. FIG. 6 is a sectional view showing operation of the food and drink packing container of FIG. 5.

As appreciated in FIGS. 5 and 6, a boring protrusion 6, which is manufactured through a separate process, is bonded to part of the cover 3, which is separably attached to a projecting part 5 extending outwards from a flange 4 of a container body 2, using a means such as an adhesive. Therefore, as shown in FIG. 6, when the part of the cover 3 is separated from the projecting part 5 and folded in the direction designated by the arrow, the boring protrusion 6 bores a hole through the cover 3.

### INDUSTRIAL APPLICABILITY

As described above, in the present invention, at least one boring protrusion, which can bore a hole through the cover of a food and drink packing container, is provided in a flange formed in an upper end of the food and drink packing container. Therefore, before the cover, a relatively large area of which is attached to the flange of the container body by heat-sealing, is opened, the hole is bored through the cover by the boring protrusion to equilibrate pressures between the inside and the outside of the food and drink packing container. Thereafter, the cover, which is attached to the flange of the container body, can be easily opened even using a relatively small force.

Although the boring protrusions have been described and shown as having the above-mentioned shapes in the specification and drawings, the boring protrusion may be provided in a shape and by a forming method different from those of the above-mentioned boring protrusions.

1. A food and drink packing container, comprising:
a container body to contain food and drink therein, with a flange provided on an upper end of the container body; and
a film type cover attached to the flange by heat-sealing to prevent the food and drink from spilling from the container body, wherein
at least one projecting part extends outwards from the flange and is covered with the cover, and a boring protrusion for boring a hole through the cover is provided at a predetermined position in the projecting part.

2. (canceled)

3. The food and drink packing container according to claim 1, wherein the boring protrusion is provided on the projecting part, and a passing hole is formed through the cover at a position corresponding to the boring protrusion.

4. The food and drink packing container according to claim 1, wherein the boring protrusion is formed by protruding part of the projecting part upwards using forming means after the projecting part is covered with the cover.

5. The food and drink packing container according to claim 3, wherein a bending groove is formed in a lower surface of the projecting part to facilitate bending of the projecting part.

6. The food and drink packing container according to claim 4, wherein a bending groove is formed in a lower surface of the projecting part to facilitate bending of the projecting part.

7. The food and drink packing container according to claim 1, wherein the boring protrusion is made of material having a higher stiffness than that of the cover such that the boring protrusion bores the hole through the cover, but having a lower stiffness than that of the container body to prevent the container body from being scratched by contact with the boring protrusion.
